(19) United States
(12) Patent Application Publication
(10) Pub. No.: US 2019/0068113 A1
(43) Pub. Date: Feb. 28, 2019

(54) SOLAR PANEL TRACING EQUIPMENT AND METHOD AND DEVICE OF CONTROLLING THE SAME, POWER GENERATOR AND POWER SYSTEM

(71) Applicant: BOE Technology Group Co., Ltd., Beijing (CN)

(72) Inventors: Wenbo Li, Beijing (CN); Zhihong Du, Beijing (CN)

(21) Appl. No.: 16/007,522

(22) Filed: Jun. 13, 2018

(30) Foreign Application Priority Data
Aug. 31, 2017 (CN) 201710772494.9

(51) Int. Cl. H02S 20/32; G05D 3/12

(52) U.S. Cl. CPC H02S 20/32; G05D 3/12

(57) ABSTRACT

Solar panel tracing equipment includes: a panel support, a sensor array, a drive mechanism and a control mechanism. The panel support is configured for mounting of a solar panel. The sensor array includes 4n light sensors distributed in a region coplanarly and configured to sense a light and generate a light intensity signal, wherein n is a positive integer. The drive mechanism includes a first driver element configured to drive the solar panel mounted on the panel support to rotate about a first rotation axis, and a second driver element configured to drive the solar panel mounted on the panel support to rotate about a second rotation axis. The control mechanism is configured to send the tracing drive signal to the first driver element and/or the second driver element in accordance with the light intensity signal received from the 4n light sensors.

### CROSS-REFERENCE TO RELATED APPLICATION(S)

This application claims priority to Chinese Patent Application No. 201710772494.9 filed on Aug. 31, 2017 in the State Intellectual Property Office of China, the disclosure of which is hereby incorporated by reference in its entirety.

### TECHNICAL FIELD

The present disclosure relates to the field of solar power generation, and particularly, to a solar panel tracing equipment and a method and a device of controlling the same, a power generator, and a power system.

### BACKGROUND

Due to its clean and renewable nature, solar energy has now become a clean energy that has received much attention. A solar power generator that converts solar energy into electrical energy has been widely used at present. Solar panel is a core component of the solar power generator and can directly convert light energy into electrical energy through a photoelectric effect or a photochemical effect.

When the solar panel is generating electricity, its power generation efficiency is related to the light intensity of a light irradiating the solar panel. The power generation efficiency of the solar panel increases when the light intensity increases. However, when the sun is used as a light source for the solar panel, due to the rotation and revolution of the earth, the irradiation angle of the sunlight irradiated on the same solar panel will change, and the change of the irradiation angle of the sunlight will cause the light intensity to change. The change of the light intensity makes it impossible for the light intensity of the light received by the solar panel to remain stable, which reduces the power generation efficiency of the solar power generator.

### SUMMARY

In accordance with an aspect of the present disclosure, there is provided a solar panel tracing equipment comprising: a panel support configured for mounting of a solar panel; a sensor array comprising 4n light sensors distributed in a region coplanarly and configured to sense a light and generate a light intensity signal, a plane where the 4n light sensors are in being parallel substantially to a plane where the solar panel mounted on the panel support is in, wherein the n is a positive integer; a drive mechanism comprising: a first driver element configured to drive the solar panel mounted on the panel support to rotate about a first rotation axis after receiving a tracing drive signal, and a second driver element configured to drive the solar panel mounted on the panel support to rotate about a second rotation axis after receiving the tracing drive signal; and a control mechanism being in signal connections with the sensor array and the drive mechanism, respectively, and configured to send the tracing drive signal to the first driver element and/or the second driver element in accordance with the light intensity signal received from the 4n light sensors.

In some embodiment, the region is a rectangular region; and the 4n light sensors are distributed in an array in the rectangular region, or, the 4n light sensors are distributed uniformly along four sides of the rectangular region, or, the 4n light sensors are distributed uniformly at four corners of the rectangular region.

In some embodiment, the sensor array further comprises a plurality of light shields which are opaque to light and are disposed in a one-to-one correspondence with the light sensors, each of the light shields is hollow and is provided with a light hole at one end, the light sensors are respectively provided in the light shields, and light-sensitive ends of the light sensors respectively face towards the light holes of the light shields.

In some embodiment, the first rotation axis and the second rotation axis are perpendicular to each other, both a plane normal to the first rotation axis and a plane normal to the second rotation axis are perpendicular to the plane where the solar panel mounted on the panel support is in, and, the first rotation axis and the second rotation axis are parallel substantially to two symmetry axes of the solar panel, respectively.

In some embodiment, the control mechanism is further configured to send the tracing drive signal to a server.

In some embodiment, the drive mechanism further comprises a first connection bracket and a second connection bracket, a housing of the first driver element is fixedly connected to the panel support, a drive shaft of the first driver element is fixedly connected to the first connection bracket, a drive shaft of the second driver element is fixedly connected to the second connection bracket, and the first connection bracket is fixedly connected to the second connection bracket.

In some embodiment, both the first driver element and the second driver element are stepper motors.

In accordance with another aspect of the present disclosure, there is provided a solar power generator, comprising: a solar panel, and the solar panel tracing equipment of any one of the above embodiments, the solar panel being mounted on the panel support.

In some embodiment, the solar power generator can further comprise: a protective mechanism configured to protect the panel support mounted with the solar panel, the protective mechanism being in signal connection with the control mechanism.

In some embodiment, the solar power generator can further comprise: a server configured for storage and receiving-transmitting of a parameter, the server being in signal connection with the control mechanism.

In accordance with another aspect of the present disclosure, there is provided a solar power system, comprising: a plurality of solar power generators, wherein at least one of the solar power generators is the solar power generator of any one of the above embodiments.

In some embodiment, the at least one of the solar power generators further comprises: a protective mechanism configured to protect the panel support mounted with the solar panel, the protective mechanism being in signal connection with the control mechanism.

In some embodiment, the solar power system can further comprise: a server configured for storage and receiving-transmitting of a parameter, the server being in signal connection with the control mechanism of each of the solar power generators, the control mechanism being further configured to receive the tracing drive signal and/or weather information from the server.

In accordance with yet another aspect of the present disclosure, there is provided method of controlling the solar panel tracing equipment of any one of the above embodiments, and the method comprises: if a first difference between a total light intensity received by light sensors located on one side of a first symmetry axis of the 4n light sensors and a total light intensity received by light sensors located on the other side of the first symmetry axis is greater than or equals to a first preset threshold, sending the tracing drive signal to the first driver element so that the first driver element drives the solar panel to rotate about the first rotation axis until the first difference is less than the first preset threshold, wherein, the first symmetry axis is parallel substantially to the first rotation axis; if a second difference between a total light intensity received by light sensors located on one side of a second symmetry axis of the 4n light sensors and a total light intensity received by light sensors located on the other side of the second symmetry axis is greater than or equals to a second preset threshold, sending the tracing drive signal to the second driver element so that the second driver element drives the solar panel to rotate about the second rotation axis until the second difference is less than the second preset threshold, wherein, the second symmetry axis is parallel substantially to the second rotation axis, and the first symmetry axis and the second symmetry axis are perpendicular to each other.

In some embodiment, the sending the tracing drive signal to the first driver element so that the first driver element drives the solar panel to rotate about the first rotation axis, comprises: rotating the solar panel towards a side of the first symmetry axis where a greater total light intensity is received by the light sensors located on the side of the first symmetry axis; and the sending the tracing drive signal to the second driver element so that the second driver element drives the solar panel to rotate about the second rotation axis, comprises: rotating the solar panel towards a side of the second symmetry axis where a greater total light intensity is received by the light sensors located on the side of the second symmetry axis.

In some embodiment, rotation of the solar panel about the first rotation axis and rotation of the solar panel about the second rotation axis are step rotations within a preset rotation angle ranged from about 45° to about 135°, and a rotation angle per step rotation is about 5°.

In accordance with yet still another aspect of the present disclosure, there is provided device of controlling the solar panel tracing equipment of any one of the above embodiments, and the device comprises: a first control unit configured to, if a first difference between a total light intensity received by light sensors located on one side of a first symmetry axis of the 4n light sensors and a total light intensity received by light sensors located on the other side of the first symmetry axis is greater than or equals to a first preset threshold, sending the tracing drive signal to the first driver element so that the first driver element drives the solar panel to rotate about the first rotation axis until the first difference is less than the first preset threshold, wherein, the first symmetry axis is parallel substantially to the first rotation axis; and a second control unit configured to, if a second difference between a total light intensity received by light sensors located on one side of a second symmetry axis of the 4n light sensors and a total light intensity received by light sensors located on the other side of the second symmetry axis is greater than or equals to a second preset threshold, sending the tracing drive signal to the second driver element so that the second driver element drives the solar panel to rotate about the second rotation axis until the second difference is less than the second preset threshold, wherein, the second symmetry axis is parallel substantially to the second rotation axis, and the first symmetry axis and the second symmetry axis are perpendicular to each other.

It is understood that other embodiments and configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The detailed description of the present disclosure will be described in detail below with reference to the accompanying drawings. The following descriptions are intended to be illustrative and should not be considered to limit the scope of the disclosure.

FIG. 1 is a schematic view showing a structure of a solar panel tracing equipment according to an embodiment of the present disclosure;

FIG. 2 is a schematic view showing an arrangement of a sensor array according to an embodiment of the present disclosure;

FIG. 3 is a schematic view showing another arrangement of a sensor array according to an embodiment of the present disclosure;

FIG. 4 is a schematic view showing yet another arrangement of a sensor array according to an embodiment of the present disclosure;

FIG. 5 is a schematic view showing a structure of a light shield according to an embodiment of the present disclosure;

FIG. 6 is a block diagram of a solar panel tracing equipment according to an embodiment of the present disclosure; and

FIG. 7 is a flowchart showing steps of a method of controlling a solar panel tracing equipment according to an embodiment of the present disclosure.

### DETAILED DESCRIPTION

Technique solutions in embodiments of the present disclosure will be described clearly and completely hereinafter with reference to the attached drawings in the embodiments of the present disclosure. Obviously, the described embodiments are only some of embodiments of the present disclosure, instead of all the embodiments of the present disclosure. For those skilled in the art, all other embodiments achieved by referring to the following embodiments of the present disclosure without involving any inventive steps fall into the scope of the present disclosure.

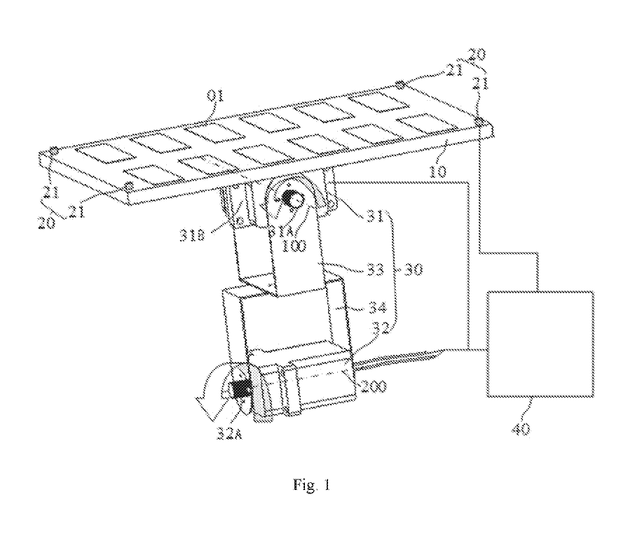

Referring to FIG. 1, according to embodiments of the present disclosure, there is provided a solar panel tracing equipment. The solar panel tracing equipment comprises: a panel support 10, a sensor array 20 disposed on the panel support 10, a drive mechanism 30 and a control mechanism 40.

The panel support 10 is configured for mounting of a solar panel 01. In the present embodiment, the solar panel 01 is rectangular.

Referring to FIG. 1, the sensor array 20 comprises a plurality of light sensors 21 configured to sense light intensity of a light received and generate a light intensity signal. In the present embodiment, the sensor array 20 comprises four light sensors 21. As shown in FIG. 1, the four light sensors 21 are respectively at four corners of the panel support 10 and are in a rectangular distribution. The four light sensors 21 are coplanar, and a plane where the four light sensors are in is parallel substantially to a plane where the solar panel 01 is in. When all the four light sensors 21 face rightly a light source, light intensity signals generated by the four light sensors 21 are the same, which indicates that the solar panel 01 face rightly the light source at the moment. When light intensity signals generated by the four light sensors 21 are different, it indicates that the solar panel 01 does not face rightly the light source at the moment.

Referring to FIG. 1, the drive mechanism 30 comprises: a first driver element 31 and a second driver element 32. In the present embodiment, both the first driver element 31 and the second driver element 32 are stepper motors, in order to improve the control accuracy. Both the first driver element 31 and the second driver element 32 are connected to the panel support 10. As shown in FIG. 1, the drive mechanism 30 further comprises a first connection bracket 33 and a second connection bracket 34, a housing 31B of the first driver element 31 is fixedly connected to the panel support 10, a drive shaft 31A of the first driver element 31 is fixedly connected to the first connection bracket 33, a drive shaft 32A of the second driver element 32 is fixedly connected to the second connection bracket 34, and the first connection bracket 33 is fixedly connected to the second connection bracket 34. When the housing 31B of the first driver element 31 rotates around the drive shaft 31A of the first driver element 31 (along a direction indicated by the upper arrow or along its reverse direction, as shown in FIG. 1), it brings the panel support 10 to rotate. When the drive shaft 32A of the second driver element 32 rotates (along a direction indicated by the lower arrow or along its reverse direction, as shown in FIG. 1), it brings both the first driver element 31 and the panel support 10 to rotate.

According to embodiments of the present disclosure, the first driver element 31 and the second driver element 32 are each driven by the tracing drive signal received. In the embodiment where both the first driver element 31 and the second driver element 32 are stepper motors, the tracing drive signal can be pulse signal. After receiving the tracing drive signal, the first driver element 31 drives the solar panel 01 mounted on the panel support 10 to rotate about the first rotation axis 100. In the present embodiment, the first rotation axis 100 coincides with an axis of the drive shaft 31A of the first driver element 31. After receiving the tracing drive signal, the second driver element 32 drives the solar panel 01 mounted on the panel support 10 to rotate about the second rotation axis 200. In the present embodiment, the second rotation axis 200 coincides with an axis of the drive shaft 32A of the second driver element 32.

The control mechanism 40 is in signal connections with the sensor array 20 and the drive mechanism 30, respectively, and configured to send the tracing drive signal to the first driver element 31 or the second driver element 32 or both in accordance with the light intensity signals received from the four light sensors 21. Specifically, after receiving the light intensity signals from the four light sensors 21, by judging the difference between the four light intensity signals, the control mechanism determines whether or not the plane where the four light sensors 21 are in faces rightly the light source, that is, it determines whether or not the solar panel 01 faces rightly the light source. Once the solar panel 01 does not face rightly the light source, the first driver element 31 and the second driver element 32 drive the solar panel 01 to rotate until the light intensity signals from the four light sensors 21 become the same, as a result, the solar panel 01 can face rightly the light source.

According to embodiments of the present disclosure, the number of light sensors 21 in the sensor array 20 may not be limited to the four in the abovementioned embodiment, and the detection accuracy may be improved by increasing the number of light sensors 21. According to embodiments of the present disclosure, the sensor array 20 may comprise 4n light sensors 21, in which n is a positive integer. The 4n light sensors 21 are distributed in a rectangular region coplanarly, and a panel where the 4n light sensors 21 are in is parallel substantially to a plane where the solar panel 01 mounted on the panel support 10 is in.

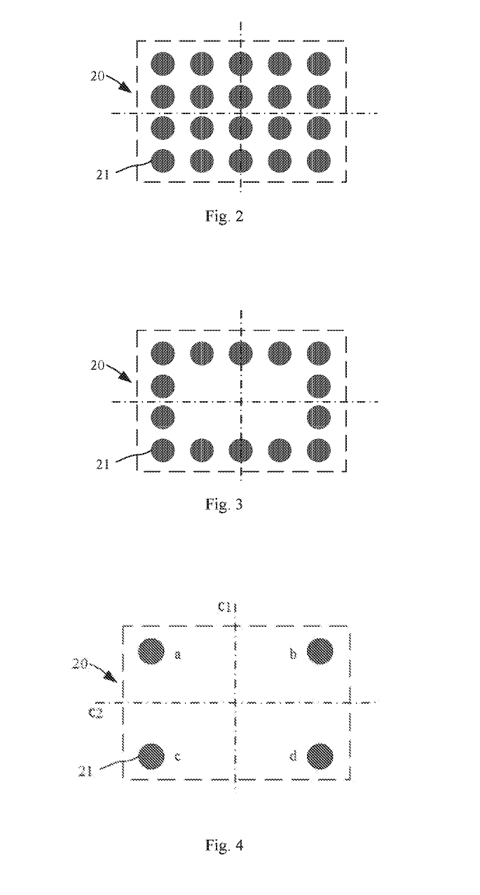

Specific examples of arrangement of the 4n light sensors 21 are shown in FIG. 2 to FIG. 4. In the example of FIG. 2, in the sensor array 20, the 4n light sensors 21 are distributed in an array in the rectangular region. In the example of FIG. 3, in the sensor array 20, the 4n light sensors 21 are distributed uniformly along four sides of the rectangular region. In the example of FIG. 4, in the sensor array 20, the 4n light sensors 21 are distributed uniformly at four corners of the rectangular region. In order to improve the detection accuracy, the 4n light sensors 21 in the rectangular region are equally distributed in the four equally partitioned blocks divided by the two center lines of the rectangular region. The rectangular region may have a coincident part with the solar panel, and may also be provided on the outside of the solar panel. In an exemplary embodiment, in order to improve the detection accuracy, the center of the rectangular region coincides with the center of the solar panel, and the sides of the rectangular region are parallel substantially to the sides of the solar panel. That is, the area of the rectangular region coincides with the area of the solar panel. In the specific implementation, the 4n light sensors can be provided on the solar panel mounted on the panel support, or can be on the panel support.

In order to increase adjustment range of the solar panel 01, in one specific embodiment, the first rotation axis 100 and the second rotation axis 200 are perpendicular to each other, both a plane normal to the first rotation axis 100 and a plane normal to the second rotation axis 200 are perpendicular to the plane where the solar panel 01 mounted on the panel support 10 is in, and, the first rotation axis 100 and the second rotation axis 200 are parallel substantially to two symmetry axes of the solar panel 01, respectively. In the specific implementation, the drive shaft 31A of the first driver element 31 and the drive shaft 32A of the second driver element 32 are perpendicular to each other, which increases the adjustment range of the solar panel for a wide range of adjustment.

In order to improve detection sensitivity of each light sensor 21 to a light that faces right a light-sensitive end 211 of the each light sensor 21, in a specific embodiment, referring to FIG. 5, the sensor array 20 further comprises a plurality of light shields 22, and the light shields 22 are disposed in a one-to-one correspondence with the light sensors 21. Each light shield 22 is opaque to light. Each light shield 22 is hollow and is provided with a light hole 221 at one end. Each light sensor 21 is disposed inside the corresponding light shield 22. The light-sensitive end 211 of the light sensor 21 faces towards the light hole 221. When the light hole 221 of the light shield 22 faces rightly a light source, a light intensity signal generated by the light sensors 21 is the strongest. Therefore, by judging whether or not the light intensity signal generated by the light sensor 21 is at a maximum value, it is checked whether or not the light sensor 21 faces rightly the light source, thereby determining whether or not the solar panel 01 faces rightly the light source.

In order to improve conversion efficiency of light energy, in a specific embodiment, each light shield 22 is made of photoelectric material, so that the light shield 22 can also use solar energy to generate electricity, to increase the conversion efficiency of light energy.

In the solar panel tracing equipment according to the embodiments of the present disclosure, when the light irradiation angle changes, the sensor array 20 senses different light intensities received by different parts of the solar panel and sends light intensity signals to the control mechanism 40. Based on the light intensity signals, the control mechanism 40 sends tracing drive signals to the first driver element 31 and the second driver element 32 of the drive mechanism 30 so that the first driver element 31 and the second driver element 32 drive the solar panel to rotate around the first rotation axis 100 and the second rotation axis 200, respectively, thereby respectively adjusting the light irradiation angles of the solar panel in either direction so that the light intensities received by the different parts of the solar panel tend to be uniform. As a result, the power generation efficiency of the solar panel can be stabilized, which improves the situation where the irradiation intensity received by the solar panel in the related art is unstable and thus results in a low power generation efficiency of the solar power generation device.

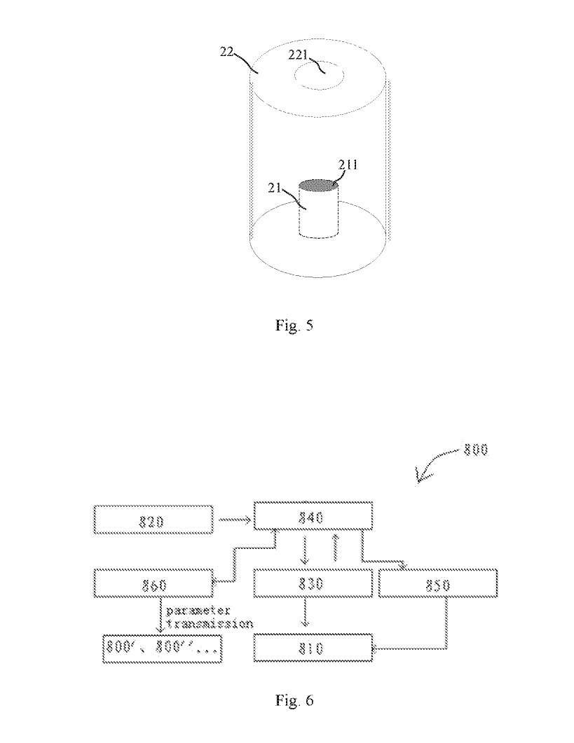

Based on a same inventive concept, according to embodiments of the present disclosure, there is provided a solar power generator. The solar power generator comprises: a solar panel, and the solar panel tracing equipment according to any of the abovementioned embodiments. The solar panel is mounted on the panel support. Referring to FIG. 6, a solar power generator 800 mainly comprises: a solar support 810 to which a solar panel is mounted, a sensor array 820 provided to the panel support 810 and configured to sense a light irradiated onto the solar panel and generate a light intensity signal, a drive mechanism 830 configured to adjust a light irradiation angle of the panel support 810, and a control mechanism 840 being in signal connections with the sensor array 820 and the drive mechanism 830, respectively, and configured to send the tracing drive signal to the drive mechanism 830 in accordance with the light intensity signal received from the sensor array 820. It should be noted that, for the sake of clarity, only some structures and components related to the inventive concept of the present disclosure are described and illustrated herein, but the solar power generator 800 provided by the present disclosure may also comprise other necessary structures and/or components. For example, a central processing module, a power supply module for power supply, a liquid crystal display module for visual display, and the like.

According to embodiments of the present disclosure, since the solar power generator incorporates the solar panel tracing equipment described in the above embodiments, it is also possible to improve the situation where the irradiation intensity received by the solar panel in the related art is unstable and thus results in a low power generation efficiency of the solar power generation device. Its principle and specific embodiments refer to the above embodiments of the solar panel tracing equipment, and the details are not described herein again.

To protect the solar panel from rain and snow, as shown in FIG. 6, according to embodiments of the present disclosure, the solar power generator 800 may further comprise a protective mechanism 850 configured for protecting the panel support 810 mounted with the solar panel. The protective mechanism 850 and the control mechanism 840 are in signal connection. In a specific embodiment, the protective mechanism 850 comprises a protective shield and a shield driving component that is in a driving connection with the protective shield. The protective shield can be opened or closed under the driving of the shield driving component, and the protective shield covers over the solar panel mounted on the panel support 810 when opened. The control mechanism is in signal connection with the shield driving component and is configured to send a protective drive signal to the protective shield according to received weather information so that the shield driving component drives the protective shield to open or close. For example, in rain and snow weather, the control mechanism 840 may generate a protective drive signal in accordance with the received weather information, so that the protective shield opens to cover over the solar panel.

As shown in FIG. 6, according to an embodiment of the present disclosure, the solar power generator 800 may further comprise a server 860 configured for storage and receiving-transmitting of a parameter. The parameter described herein may comprise, but is not limited to, the above-mentioned tracing drive signal, the protective drive signal, and the like. For example, in a solar power system including at least one solar power generator 800 described above, when the solar panel tracing equipment in the at least one solar power generator 800 described above receives a tracing drive signal, the server 860 can receive and store the tracing drive signal. Moreover, via the server 860, the tracing drive signal may be sent to other solar power generators 800′, 800″, . . . etc. in the solar power system, for adjusting the light irradiation angle of the solar supports in these solar power generators. That is, by provision of the server, it is possible to achieve signal sharing among these solar power generators in the solar power system including the at least one solar power generator 800 described above. For another example, in the example where the solar power generator 800 comprises a protective mechanism 850 and a server 860, weather information may be transmitted by the server 860 to the control mechanism 840.

Based on a same inventive concept, according to embodiments of the present disclosure, there is provided a solar power system. The solar power system comprises a plurality of solar power generators, wherein at least one of the solar power generators is the solar power generator according to the aforementioned embodiments.

According to embodiments of the present disclosure, in order to increase the tracing adjustment efficiency of each of the solar power generators in the solar power system, the tracing drive signal of the solar panel tracking equipment comprised in the solar power generator according to the above embodiment may be shared to other solar power generators. In a specific embodiment, the solar power system further comprises a server configured for storage and receiving-transmitting of a parameter. The parameter described herein may comprise, but is not limited to, the above-mentioned tracing drive signal, and the like. By provision of the server, it is possible to achieve signal sharing among these solar power generators in the solar power system including the at least one solar power generator 800 described above. In this way, in a solar power system including a plurality of solar power generators, only at least one of the solar power generators needs all the configurations/components of the solar power generator according to the aforementioned embodiments, while the remaining solar power generators only need to comprise the panel support, the drive mechanism and the control mechanism according to the aforementioned embodiments, without the sensor array. When the at least one solar power generator obtains a light intensity signal through the sensor array thereof, a tracing drive signal associated with the light intensity signal is sent from the control mechanism in the at least one solar power generator to the server, while the control mechanisms in the remaining solar power generators may obtain the tracing drive signal from the server and then adjust the light irradiation angle of the panel support in each of the solar power generators based on the received tracing drive signal.

Of course, in another embodiment, each of the solar power generators in the solar power system may be the solar power generator according to the abovementioned embodiments, that is, each comprises the panel support, the drive mechanism, the control mechanism, and the sensor array according to the abovementioned embodiments.

Based on the same inventive concept, according to embodiments of the present disclosure, a method of controlling the solar panel tracing equipment according to the above embodiments is also provided. In this control method, the rectangular region where the plurality of light sensors are distributed is divided into four blocks according to two center lines C1 and C2 of the rectangular region. Referring to FIG. 4 , four light sensors are taken as an example, and the rectangular regions where the light sensors are located is divided into four blocks uniformly according to two center lines C1 and C2 of the rectangular region. Each block has one light sensor a, b, c, or d.

By judging whether or not there is a difference between the sum of the light intensity signals from the light sensors on one side of each central axis and the sum of the light intensity signals from the light sensors on the other side of the each central axis, it can be determined whether or not the solar panel faces rightly the light source. If the difference does not exceed a certain threshold, it is determined that deviation of the solar panel from a position where it faces rightly the light source is small, at this moment, no positional adjustment of the solar panel is required. If the difference exceeds the certain threshold, a positional adjustment of the solar panel is required. In the adjustment, the rotation axis of the solar panel is required to be parallel to the central axis of the rectangular region where the light sensors are located, ensuring control accuracy.

Based on the principle of the abovementioned control method, in combination with FIG. 1 and FIG. 4, the method of controlling the solar panel tracing equipment, according to the present embodiment, comprises: if a first difference between a total light intensity received by light sensor(s) (for example, a in FIG. 4) located on one side of a first symmetry axis (for example, C1 in FIG. 4) of the 4n light sensors (for example, a, b, c and d in FIG. 4) and a total light intensity received by light sensor(s) (for example, b in FIG. 4) located on the other side of the first symmetry axis is greater than or equals to a first preset threshold, sending the tracing drive signal to the first driver element (for example, 31 in FIG. 1) so that the first driver element drives the panel support (for example, 10 in FIG. 1) mounted with the solar panel (for example, 01 in FIG. 1) to rotate about the first rotation axis (for example, 100 in FIG. 1) until the first difference is less than the first preset threshold, wherein, the first symmetry axis (for example, C1 in FIG. 4) is parallel substantially to the first rotation axis (for example, 100 in FIG. 1); if a second difference between a total light intensity received by light sensor(s) (for example, c in FIG. 4) located on one side of a second symmetry axis (for example, C2 in FIG. 4) of the 4n light sensors (for example, a, b, c and d in FIG. 4) and a total light intensity received by light sensor(s) (for example, d in FIG. 4) located on the other side of the second symmetry axis is greater than or equals to a second preset threshold, sending the tracing drive signal to the second driver element (for example, 32 in FIG. 1) so that the second driver element drives the panel support (for example, 10 in FIG. 1) mounted with the solar panel (for example, 01 in FIG. 1) to rotate about the second rotation axis (for example, 200 in FIG. 1) until the second difference is less than the second preset threshold, wherein, the second symmetry axis (for example, C2 in FIG. 4) is parallel substantially to the second rotation axis (for example, 200 in FIG. 1), and the first symmetry axis and the second symmetry axis are perpendicular to each other.

In some embodiments, the first preset threshold and the second preset threshold can be the same or different.

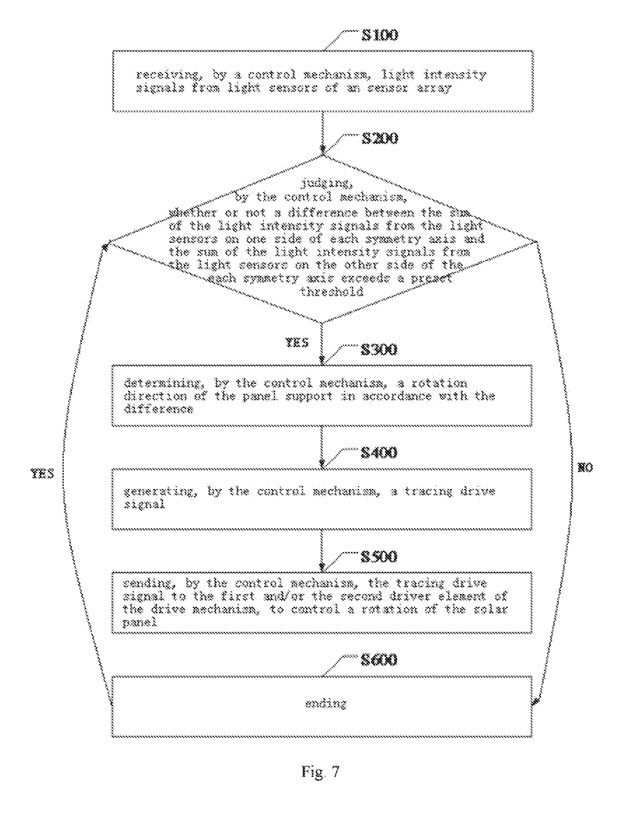

Referring to FIG. 7, in a specific implementation, the abovementioned controlling method can comprise the following steps: a step S100 of receiving, by the control mechanism, light intensity signals from the light sensors of the sensor array; a step S200 of judging, by the control mechanism, whether or not a difference between the sum of the light intensity signals from the light sensors on one side of each symmetry axis and the sum of the light intensity signals from the light sensors on the other side of the each symmetry axis exceeds a preset threshold; if yes, go to a step S300, and if no, go to a step S600; the step S300 of determining, by the control mechanism, a rotation direction of the panel support in accordance with the difference; a step S400 of generating, by the control mechanism, a tracing drive signal; a step S500 of sending, by the control mechanism, the tracing drive signal to the first and/or the second driver element of the drive mechanism, to control a rotation of the solar panel; and the step S600 of ending.

Regarding the step S200, specifically, four light sensors a, b, c, and d in FIG. 4 are taken as an example, the light intensity signals received by the control mechanism from the four light sensors are Va, Vb, Vc, and Vd, respectively. The sum of the light intensity signals from the light sensors at one side of the symmetry axis C1 and the sum of the light intensity signals from the light sensors at the other side of the symmetry axis C1 are Va+Vc and Vb+Vd, respectively. Once there is a difference between the Va+Vc and Vb+Vd, it is judged whether or not the difference exceeds the preset threshold. If the difference exceeds the preset threshold, it is determined that there needs to rotate the panel support around a rotation axis (for example, the first rotation axis 100) that is parallel to the symmetry axis C1. The same way is applied to judgment of a difference between the sums of the light intensity signals from the light sensors at both sides of the symmetry axis C2.

Regarding the step S300, specifically, if the sum of the light intensity signals from the light sensors at the one side of the symmetry axis C1 or C2 is greater than the sum of the light intensity signals from the light sensors at the other side of the symmetry axis C1 or C2, it is determined that the one side of the symmetry axis C1 or C2 is closer to the light source than the other side, and it needs to rotate panel support towards the one side of symmetry axis C1 or C2.

Regarding the step S400, the tracing drive signal should comprise rotation direction information and rotation angle information, and the rotation angle should be set according to the required control accuracy.

Regarding the step S500, when the panel support is rotating, the light intensity signals generated by the light sensors vary accordingly. At this moment, the step S200 is required to be performed repeatedly, that is, to judge whether or not the difference between the sum of the light intensity signals from the light sensors on one side of the symmetry axis C1 or C2 and the sum of the light intensity signals from the light sensors on the other side of the symmetry axis C1 or C2 exceeds the preset threshold; if the difference still exceeds the preset threshold, go to the steps S300, S400 and S500; and if the difference does not exceed the preset threshold, go to a step S600, that is, positional adjustment of the solar panel is finished.

It is learned from the abovementioned steps, in a specific implementation, the sending the tracing drive signal to the first driver element so that the first driver element drives the solar panel to rotate about the first rotation axis, specifically comprises: rotating the solar panel towards a side of the first symmetry axis where a greater total light intensity is received by the light sensors located on the side of the first symmetry axis. Similarly, the sending the tracing drive signal to the second driver element so that the second driver element drives the solar panel to rotate about the second rotation axis, specifically comprises: rotating the solar panel towards a side of the second symmetry axis where a greater total light intensity is received by the light sensors located on the side of the second symmetry axis.

When controlling the rotation of the solar panel, in order to ensure the adjustment accuracy, the solar panel can take a stepping rotation, and each time it rotates a smaller angle, which facilitates the adjustment. In one embodiment, the sending the tracing drive signal to the first driver element so that the first driver element drives the solar panel to rotate about the first rotation axis, specifically comprises: causing the solar panel to perform a stepping rotation according to a preset first rotation angle. Similarly, the sending the tracing drive signal to the second driver element so that the second driver element drives the solar panel to rotate about the second rotation axis, specifically comprises: causing the solar panel to perform a stepping rotation according to a preset second rotation angle.

When the first driver element and the second driver element are stepper motors, because the stepper motor uses a wired driver, and in order to prevent the stepper motor from rotating too much and thus winding the signal wire around the stepper motor, thereby damaging the equipment, total rotation angles of the first driver element and the second driver element need to be kept within a certain range to prevent the signal wire from being wound. In a specific embodiment, the sending the tracing driver signal to the first driver element so that the first driver element drives the solar panel to rotate around the first rotation axis, specifically comprises: causing a total rotation angle of the solar panel in either direction to be less than or equal to a preset rotation angle threshold. Similarly, the sending the tracing driver signal to the second driver element so that the second driver element drives the solar panel to rotate around the second rotation axis, specifically comprises: causing a total rotation angle of the solar panel in either direction to be less than or equal to the preset rotation angle threshold. The rotation angle threshold needs to be set according to a length of the signal wire and occupation of the space where the stepper motor is located. Generally, it is necessary to ensure that the stepper motor cannot make a full rotation. The rotation angle may specifically be ranged from about 45° to about 135°, and a rotation angle per step rotation is about 5°.

In the method of controlling the solar panel tracing equipment according to the embodiments of the present disclosure, in accordance with the difference between the sum of the total irradiation intensities from the light sensors at the one side of either symmetry axis and the sum of the total irradiation intensities from the light sensors at the other side of the either symmetry axis, it is determined that whether or not the sum of the total irradiation intensities from the light sensors at the one side and the sum of the total irradiation intensities from the light sensors at the other side are consistent with each other. When the difference is greater than or equal to the preset threshold, the tracing drive signal is sent to the first driver element and the second driver element so that the first driver element and the second driver element drive the solar panel to rotate around the first rotation axis and the second rotation axis, respectively, so as to adjust the light irradiation angle of the solar panel in either direction until the sum of the total irradiation intensities from the light sensors at the one side and the sum of the total irradiation intensities from the light sensors at the other side are consistent with each other. As a result, the power generation efficiency of the solar panel can be stabilized, which improves the situation where the irradiation intensity received by the solar panel in the related art is unstable and thus results in a low power generation efficiency of the solar power generation device.

Based on a same inventive concept, according to embodiments of the present disclosure, there is provided a device of controlling the solar panel tracing equipment according to the above embodiments. The control device comprises: a first control unit configured to, if a first difference between a total light intensity received by light sensors located on one side of a first symmetry axis of the 4n light sensors and a total light intensity received by light sensors located on the other side of the first symmetry axis is greater than or equals to a first preset threshold, sending the tracing drive signal to the first driver element so that the first driver element drives the solar panel to rotate about the first rotation axis until the first difference is less than the first preset threshold, wherein, the first symmetry axis is parallel substantially to the first rotation axis; and a second control unit configured to, if a second difference between a total light intensity received by light sensors located on one side of a second symmetry axis of the 4n light sensors and a total light intensity received by light sensors located on the other side of the second symmetry axis is greater than or equals to a second preset threshold, sending the tracing drive signal to the second driver element so that the second driver element drives the solar panel to rotate about the second rotation axis until the second difference is less than the second preset threshold, wherein, the second symmetry axis is parallel substantially to the second rotation axis, and the first symmetry axis and the second symmetry axis are perpendicular to each other.

In one specific embodiment, the first control unit is configured for: rotating the solar panel towards a side of the first symmetry axis where a greater total light intensity is received by the light sensors located on the side of the first symmetry axis. For example, the first control unit is configured for causing the solar panel to make a step rotation in a first preset rotation angle.

In an exemplary embodiment, the first control unit is configured to make a total rotation angle of the solar panel in either direction around the first symmetry axis to be smaller than or equal to a preset rotation angle threshold, and the preset rotation angle is ranged from 45° to 135°, and a rotation angle per step rotation is about 5°.

In one specific embodiment, the second control unit is configured for: rotating the solar panel towards a side of the second symmetry axis where a greater total light intensity is received by the light sensors located on the side of the second symmetry axis. For example, the second control unit is configured for causing the solar panel to make a step rotation in a second preset rotation angle.

In an exemplary embodiment, the second control unit is configured to make a total rotation angle of the solar panel in either direction around the second symmetry axis to be smaller than or equal to a preset rotation angle threshold, and the preset rotation angle is ranged from 45° to 135°, and a rotation angle per step rotation is about 5°.

It would be apparent to those skilled in the art that various modifications and alternations can be made to the embodiments of the present disclosure without departing from the spirit and scope of the present disclosure. Thus, if these modifications and alternations of the embodiments fall within the scope of the present disclosure, which is defined by the appended claims and its equivalents, the present disclosure also intends to comprise these modifications and alternations.

What is claimed is:

1. A solar panel tracing equipment comprising:
a panel support configured for mounting of a solar panel;
a sensor array comprising 4n light sensors distributed in a region coplanarly and configured to sense a light and generate a light intensity signal, a plane where the 4n light sensors are in being parallel substantially to a plane where the solar panel mounted on the panel support is in, wherein the n is a positive integer;
a drive mechanism comprising: a first driver element configured to drive the solar panel mounted on the panel support to rotate about a first rotation axis after receiving a tracing drive signal, and a second driver element configured to drive the solar panel mounted on the panel support to rotate about a second rotation axis after receiving the tracing drive signal; and
a control mechanism being in signal connections with the sensor array and the drive mechanism, respectively, and configured to send the tracing drive signal to the first driver element and/or the second driver element in accordance with the light intensity signal received from the 4n light sensors.

2. The solar panel tracing equipment of claim 1, wherein the region is a rectangular region; and the 4n light sensors are distributed in an array in the rectangular region, or, the 4n light sensors are distributed uniformly along four sides of the rectangular region, or, the 4n light sensors are distributed uniformly at four corners of the rectangular region.

3. The solar panel tracing equipment of claim 1, wherein the sensor array further comprises a plurality of light shields which are opaque to light and are disposed in a one-to-one correspondence with the light sensors, each of the light shields is hollow and is provided with a light hole at one end, the light sensors are respectively provided in the light shields, and light-sensitive ends of the light sensors respectively face towards the light holes of the light shields.

4. The solar panel tracing equipment of claim 1, wherein the first rotation axis and the second rotation axis are perpendicular to each other, both a plane normal to the first rotation axis and a plane normal to the second rotation axis are perpendicular to the plane where the solar panel mounted on the panel support is in, and, the first rotation axis and the second rotation axis are parallel substantially to two symmetry axes of the solar panel, respectively.

5. The solar panel tracing equipment of claim 1, wherein the control mechanism is further configured to send the tracing drive signal to a server.

6. The solar panel tracing equipment of claim 1, wherein the drive mechanism further comprises a first connection bracket and a second connection bracket, a housing of the first driver element is fixedly connected to the panel support, a drive shaft of the first driver element is fixedly connected to the first connection bracket, a drive shaft of the second driver element is fixedly connected to the second connection bracket, and the first connection bracket is fixedly connected to the second connection bracket.

7. The solar panel tracing equipment of claim 1, wherein both the first driver element and the second driver element are stepper motors.

8. A solar power generator, comprising: a solar panel, and the solar panel tracing equipment of claim 1, the solar panel being mounted on the panel support.

9. The solar power generator of claim 8, further comprising: a protective mechanism configured to protect the panel support mounted with the solar panel, the protective mechanism being in signal connection with the control mechanism.

10. The solar power generator of claim 8, further comprising: a server configured for storage and receiving-transmitting of a parameter, the server being in signal connection with the control mechanism.

11. A solar power system, comprising: a plurality of solar power generators, wherein at least one of the solar power generators is the solar power generator of claim 6.

12. The solar power system of claim 11, wherein the at least one of the solar power generators further comprises: a protective mechanism configured to protect the panel support mounted with the solar panel, the protective mechanism being in signal connection with the control mechanism.

13. The solar power system of claim 11, further comprising: a server configured for storage and receiving-transmitting of a parameter, the server being in signal connection with the control mechanism of each of the solar power generators, the control mechanism being further configured to receive the tracing drive signal and/or weather information from the server.

14. A method of controlling the solar panel tracing equipment of claim 1, the method comprising:
if a first difference between a total light intensity received by light sensors located on one side of a first symmetry axis of the 4n light sensors and a total light intensity received by light sensors located on the other side of the first symmetry axis is greater than or equals to a first preset threshold, sending the tracing drive signal to the first driver element so that the first driver element drives the solar panel to rotate about the first rotation axis until the first difference is less than the first preset threshold, wherein, the first symmetry axis is parallel substantially to the first rotation axis;
if a second difference between a total light intensity received by light sensors located on one side of a second symmetry axis of the 4n light sensors and a total light intensity received by light sensors located on the other side of the second symmetry axis is greater than or equals to a second preset threshold, sending the tracing drive signal to the second driver element so that the second driver element drives the solar panel to rotate about the second rotation axis until the second difference is less than the second preset threshold, wherein, the second symmetry axis is parallel substantially to the second rotation axis, and the first symmetry axis and the second symmetry axis are perpendicular to each other.

15. The method of claim 14, wherein the sending the tracing drive signal to the first driver element so that the first driver element drives the solar panel to rotate about the first rotation axis, comprises: rotating the solar panel towards a side of the first symmetry axis where a greater total light intensity is received by the light sensors located on the side of the first symmetry axis; and
the sending the tracing drive signal to the second driver element so that the second driver element drives the solar panel to rotate about the second rotation axis, comprises: rotating the solar panel towards a side of the second symmetry axis where a greater total light intensity is received by the light sensors located on the side of the second symmetry axis.

16. The method of claim 15, wherein rotation of the solar panel about the first rotation axis and rotation of the solar panel about the second rotation axis are step rotations within a preset rotation angle ranged from about 45° to about 135° , and a rotation angle per step rotation is about 5.

17. A device of controlling the solar panel tracing equipment of claim 1, the device comprising:
a first control unit configured to, if a first difference between a total light intensity received by light sensors located on one side of a first symmetry axis of the 4n light sensors and a total light intensity received by light sensors located on the other side of the first symmetry axis is greater than or equals to a first preset threshold, sending the tracing drive signal to the first driver element so that the first driver element drives the solar panel to rotate about the first rotation axis until the first difference is less than the first preset threshold, wherein, the first symmetry axis is parallel substantially to the first rotation axis; and
a second control unit configured to, if a second difference between a total light intensity received by light sensors located on one side of a second symmetry axis of the 4n light sensors and a total light intensity received by light sensors located on the other side of the second symmetry axis is greater than or equals to a second preset threshold, sending the tracing drive signal to the second driver element so that the second driver element drives the solar panel to rotate about the second rotation axis until the second difference is less than the second preset threshold, wherein, the second symmetry axis is parallel substantially to the second rotation axis, and the first symmetry axis and the second symmetry axis are perpendicular to each other.
